(19) United States
(12) Patent Application Publication
(10) Pub. No.: US 2026/0018096 A1
(43) Pub. Date: Jan. 15, 2026

(54) DRIVER CIRCUIT AND DISPLAY DEVICE

(71) Applicant: Sharp Display Technology Corporation, Kameyama City (JP)

(72) Inventors: Seiya KAWAMORITA, Kameyama City (JP); Yasuaki IWASE, Kameyama City (JP); Shinji MATSUBARA, Kameyama City (JP)

(21) Appl. No.: 19/262,539

(22) Filed: Jul. 8, 2025

(30) Foreign Application Priority Data
Jul. 9, 2024 (JP) 2024-110453

(51) Int. Cl. G09G 3/20

(52) U.S. Cl. CPC G09G 3/20; G09G 2310/0243; G09G 2310/0267; G09G 2310/0286; G09G 2310/04; G09G 2330/021; G09G 2340/0435

(57) ABSTRACT

A driver circuit for driving a plurality of signal lines includes a plurality of unit circuits including an nth unit circuit. The nth unit circuit has a setting terminal through which a setting signal is outputted to another unit circuit and a plurality of driving terminals including a first driving terminal through which a first driving signal is outputted to one of the plurality of signal lines and a second driving terminal through which a second driving signal is outputted to another one of the plurality of signal lines. The setting signal is active during a first period. The first period includes at least part of an active period of the first driving signal and at least part of an active period of the second driving signal.

### BACKGROUND

### 1. Field

The present disclosure relates to a driver circuit.

### 2. Description of the Related Art

Japanese Unexamined Patent Application Publication No. 2011-209714 discloses a driver circuit for use in a display device that performs a partial display.

The known driver circuit is undesirably large in circuit size.

### SUMMARY

According to an aspect of the disclosure, there is provided a driver circuit for driving a plurality of signal lines. The driver circuit includes a plurality of unit circuits including an nth unit circuit. The nth unit circuit has a setting terminal through which a setting signal is outputted to another unit circuit and a plurality of driving terminals including a first driving terminal through which a first driving signal is outputted to one of the plurality of signal lines and a second driving terminal through which a second driving signal is outputted to another one of the plurality of signal lines. The setting signal is active during a first period. The first period includes at least part of an active period of the first driving signal and at least part of an active period of the second driving signal.

### BRIEF DESCRIPTION OF THE DRAWINGS

FIG. 1 is a schematic view showing a configuration of a driver circuit according to the present embodiment;

FIG. 2 is a timing chart showing operation of the driver circuit according to the present embodiment;

FIG. 3 is a circuit diagram showing a configuration of a unit circuit of the driver circuit according to the present embodiment;

FIG. 4 is a circuit diagram showing a configuration of a unit circuit of the driver circuit according to the present embodiment;

FIG. 5 is a circuit diagram showing a configuration of a unit circuit of the driver circuit according to the present embodiment;

FIG. 6 is a block diagram showing a configuration of a display device according to the present embodiment;

FIG. 7 is a schematic view showing a configuration of a driver circuit according to the present embodiment;

FIG. 8 is a timing chart showing operation of the driver circuit according to the present embodiment;

FIG. 9 is a schematic view showing a configuration of a driver circuit according to the present embodiment;

FIG. 10 is a timing chart showing operation of the driver circuit according to the present embodiment;

FIG. 11 is a schematic view showing a configuration of a driver circuit according to the present embodiment;

FIG. 12 is a timing chart showing operation of the driver circuit according to the present embodiment;

FIG. 13 is a schematic view showing a configuration of a driver circuit according to the present embodiment;

FIG. 14 is a circuit diagram showing a configuration of a unit circuit of the driver circuit according to the present embodiment; and

FIG. 15 is a timing chart showing operation of the driver circuit according to the present embodiment.

### DESCRIPTION OF THE EMBODIMENTS

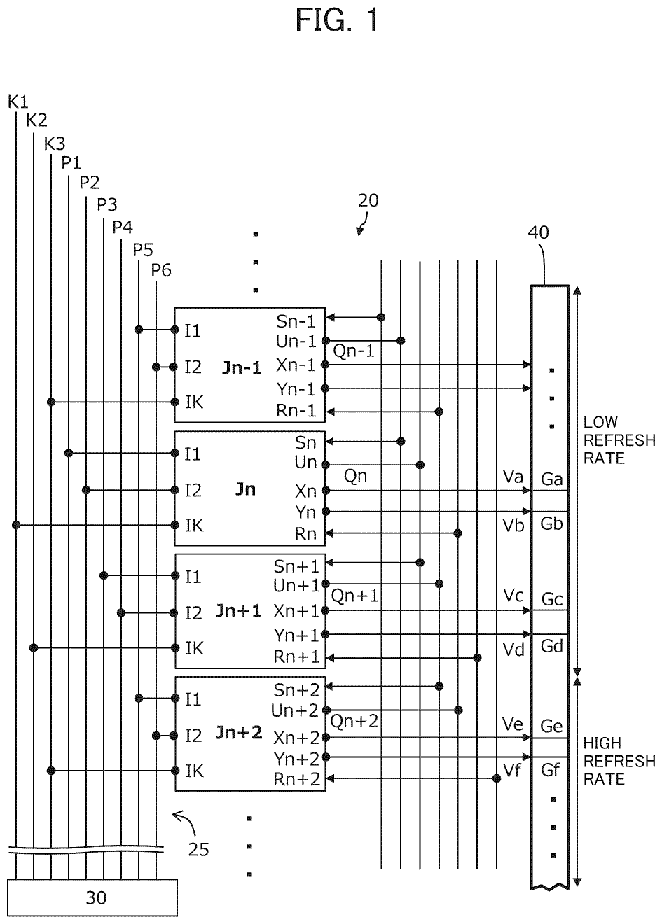

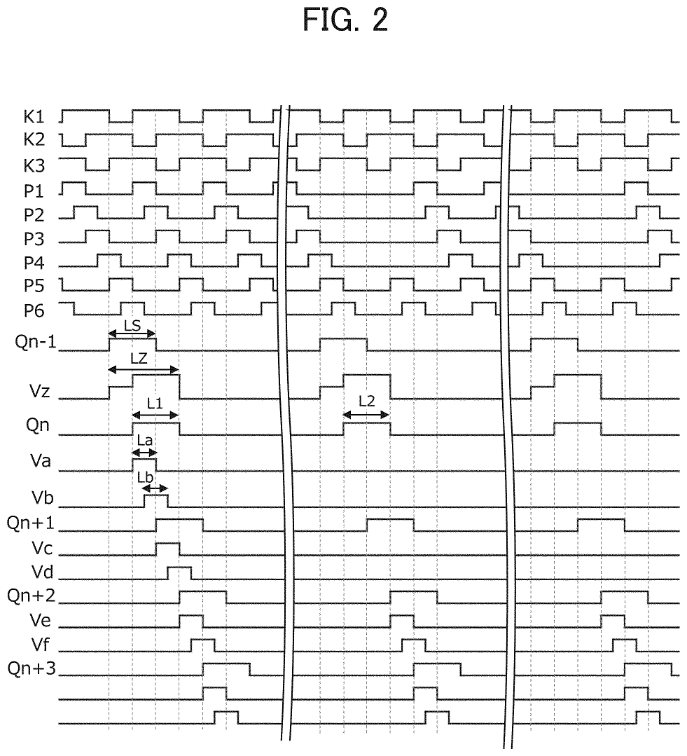

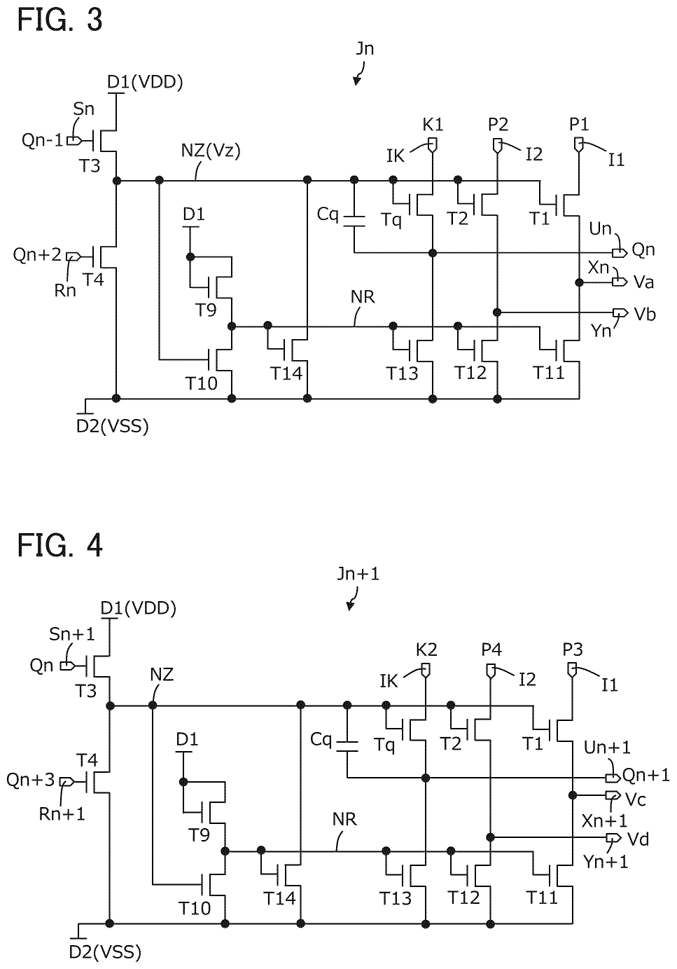

FIG. 1 is a schematic view showing a configuration of a driver circuit according to the present embodiment. FIG. 2 is a timing chart showing operation of the driver circuit according to the present embodiment. FIGS. 3 to 5 are circuit diagrams showing configurations of unit circuits of the driver circuit according to the present embodiment. As shown in FIGS. 1 to 5, a driver circuit 20 is a driver circuit for driving a plurality of signal lines (such as Ga to Gf) and includes a plurality of unit circuits (such as Jn, Jn−1, and Jn+1). The nth unit circuit Jn includes a setting terminal Un through which a setting signal On is outputted to another unit circuit (such as Jn+1) and a plurality of driving terminals including a first driving terminal Xn through which a first driving signal Va is outputted to the signal line Ga, which is one of the plurality of signal lines, and a second driving terminal Yn through which a second driving signal Vb is outputted to the signal line Gb, which is another one of the plurality of signal lines. n is a natural number. The setting signal On may have a function of setting a subsequent unit circuit. The setting signal On may have a function of resetting a preceding unit circuit.

In the driver circuit 20, the setting signal Qn is active during a first period L1, and the first period L1 includes at least part of an active period La of the first driving signal Va and at least part of an active period Lb of the second driving signal Vb. The first period L1 may include all of the active period La of the first driving signal Va and all of the active period Lb of the second driving signal Vb. The first period L1 may include all of the active period La of the first driving signal Va and part of the active period Lb of the second driving signal Vb.

In the driver circuit 20, the two signal lines Ga and Gb can be driven by the first second driving signals Va and Vb generated in the nth unit circuit Jn. This causes the driver circuit 20 to have a decreased circuit size.

The plurality of signal lines Ga to Gf may be scanning lines, and the first and second driving signals Va and Vb may be scan signals (scanning signals). The signal line Ga may be the (2n−1)th scanning line formed in a display unit 40, and the signal line Gb may be the (2n)th scanning line formed in the display unit 40.

The nth unit circuit Jn has a setting transistor Tq having two conducting terminals (source, drain) one of which a clock signal K1 is inputted through and the other of which is connected to the setting terminal Un, and a period LZ during which a gate terminal (control node NZ) of the setting transistor Tq stays active (High) may be overlapped by at least part of the active period La of the first driving signal Va and at least part of the active period Lb of the second driving signal Vb. The period LZ may be overlapped by all of the active period La of the first driving signal Va and all of the active period Lb of the second driving signal Vb (that is, the period LZ may include all of the period La and all of the period Lb). The control node NZ is at a potential Vz.

In the driver circuit 20, the setting signal On may be active during a second period L2, and the first and second driving signals Va and Vb may be non-active during the second period L2. That is, total scanning by which all of the plurality of signal lines (including Ga to Gf) are scanned and partial scanning by which only some of the plurality of signal lines (including Ge and Gf) are scanned may be performed. The setting signal On may function as a set signal, and another unit circuit (Jn+1) may be set during the first period L1 and the second period L2. This makes it possible to vary refresh rates (frequencies of rewriting) from one area to another in the display unit 40 (including the signal lines Ga to Gf) that is to be driven, making it possible to reduce power consumption.

In the examples shown in FIGS. 1 to 5, an area including the signal lines (scanning lines) Ga to Gd is refreshed at a low refresh rate, and an area including the signal lines (scanning lines) Ge and Gf is refreshed at a high refresh rate. A still image may be displayed in the low-refresh-rate area, and a moving image may be displayed in the high-refresh-rate area.

As shown in FIG. 2, in the driver circuit 20, the first and second driving signals Va and Vb may become active (rise from Low to High) in sequence within the first period L1. Part (e.g. the second half) of the active period La of the first driving signal Va and part (e.g. the first half) of the active period Lb of the second driving signal Vb may overlap each other. The first and second driving signals Va and Vb may return (from active High) to non-active in the first period L1.

As shown in FIG. 3, the nth unit circuit Jn may have a first input terminal I1 to which a first pulse signal P1 is inputted, a second input terminal I2 to which a second pulse signal P2 is inputted, a clock terminal IK to which the clock signal K1 is inputted, the setting transistor Tq, and first and second transistors T1 and T2. The first driving terminal Xn may be connected to the first input terminal I1 via the first transistor T1. The second driving terminal Yn may be connected to the second input terminal I2 via the second transistor T2. The setting terminal Un, through which Qn is outputted, may be connected to the clock terminal IK via the setting transistor Tq.

As shown in FIG. 4, the (n+1) th unit circuit Jn+1 may have a setting terminal Un+1 through which a setting signal Qn+1 is outputted to another unit circuit (such as Jn+2), a first driving terminal Xn+1 through which a first driving signal Vc is outputted to the signal line Gc, which is one of the plurality of signal lines, and a second driving terminal Yn+1 through which a second driving signal Vd is outputted to the signal line Gd, which is another one of the plurality of signal lines.

The (n+1)th unit circuit Jn+1 may have a first input terminal I1 to which a third pulse signal P3 is inputted, a second input terminal I2 to which a fourth pulse signal P4 is inputted, a clock terminal IK to which a clock signal K2 is inputted, a setting transistor Tq, and first and second transistors T1 and T2. The first driving terminal Xn+1 may be connected to the first input terminal I1 via the first transistor T1. The second driving terminal Yn+1 may be connected to the second input terminal I2 via the second transistor T2. The setting terminal Un+1, through which Qn+1 is outputted, may be connected to the clock terminal IK via the setting transistor Tq.

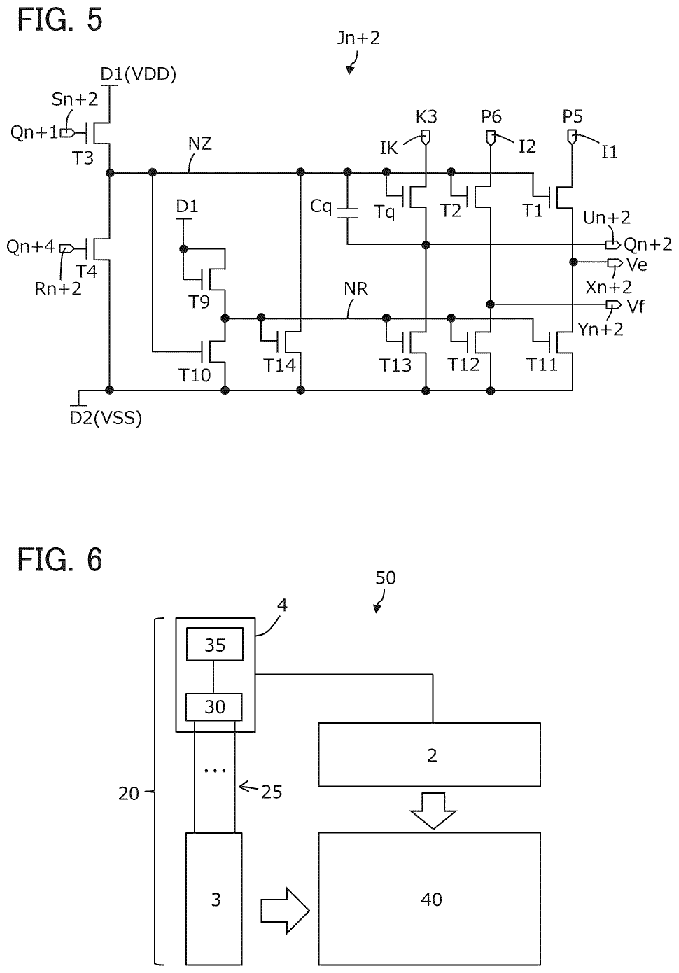

As shown in FIG. 5, the (n+2)th unit circuit Jn+2 may have a setting terminal Un+2 through which a setting signal Qn+2 is outputted to another unit circuit (such as Jn+3), a first driving terminal Xn+2 through which a first driving signal Ve is outputted to the signal line Ge, which is one of the plurality of signal lines, and a second driving terminal Yn+2 through which a second driving signal Vf is outputted to the signal line Gf, which is another one of the plurality of signal lines.

The (n+2)th unit circuit Jn+2 may have a first input terminal I1 to which a fifth pulse signal P5 is inputted, a second input terminal I2 to which a sixth pulse signal P6 is inputted, a clock terminal IK to which a clock signal K3 is inputted, a setting transistor Tq, and first and second transistors T1 and T2. The first driving terminal Xn+2 may be connected to the first input terminal I1 via the first transistor T1. The second driving terminal Yn+2 may be connected to the second input terminal I2 via the second transistor T2. The setting terminal Un+2, through which Qn+2 is outputted, may be connected to the clock terminal IK via the setting transistor Tq.

As shown in FIG. 2, in the first period L1, the first and second pulse signals P1 and P2 may become active in sequence while the clock signal K1 stays active. Although, in FIG. 2, the first and second pulse signals P1 and P2 are equal in pulse width to each other and different in phase from each other and the pulse width of the clock signal K1 is a natural number multiple of (e.g. twice as great as) the pulse width of the first and second pulse signals P1 and P2, this is not intended to impose any limitation. Further, although a timing at which the clock signal K1 becomes active (rises) and a timing at which the first pulse signal P1 becomes active (rises) are in synchronization with each other, this is not intended to impose any limitation.

The phase shift between the first and second pulse signals P1 and P2 may be equivalent to one horizontal scanning period. The clock signal K1 and the first and second pulse signals P1 and P2 may be made equal in periodicity to each other. In FIG. 2, for example, the clock signal K1 is active for 4H out of 6H periodicity, and the first and second pulse signals P1 and P2 are active for 2H out of 6H periodicity. 1H is one horizontal scanning period.

As shown in FIG. 2, the setting signal Qn may be active during the second period L2, and the numbers of pulses in the first and second pulse signals P1 and P2 during the second period L2 may be reduced.

To the driver circuit 20, a clock signal group (K1 to K3) of two or more phases including the clock signal K1 and a pulse signal group (P1 to P6) of three or more phases including the first and second pulse signals P1 and P2 may be inputted. The number of phases of the clock signal group (in FIG. 2, the three phases K1 to K3) may be smaller than the number of phases of the pulse signal group (in FIG. 2, the six phases P1 to P6).

As shown in FIGS. 1 to 3, the nth unit circuit Jn may have a control node NZ connected to the gate terminal of the setting transistor Tq and a bootstrap capacitor (transformer capacitor) Cq, and the control node NZ may be connected to the setting terminal Un via the bootstrap capacitor Cq. In a set period LS (i.e. a period during which Qn-1 is active), the setting transistor Tq may be turned on and the bootstrap capacitor Cq may be charged by the control node NZ becoming active, and the control node NZ may be boosted by the clock signal K1 rising. This enhances the driving capability of the setting transistor Tq and stabilizes the setting signal On. That is, pulses of the clock signal K1 are stably outputted through the setting terminal Un.

The control node NZ may be connected to gate terminals of the first and second transistors T1 and T2. In this case, by the control node NZ being boosted by the bootstrap capacitor Cq, the driving capabilities of the first and second transistors T1 and T2 are enhanced and the first and second driving signals Va and Vb are stabilized. That is, pulses of the first pulse signal P1 are stably outputted through the first driving terminal Xn, and pulses of the second pulse signal P2 are stably outputted through the second driving terminal Yn.

As shown in FIGS. 1 to 3, the driver circuit 20 may include a first power supply line D1 (e.g. a high-potential-side power supply line) and a second power supply line D2 (e.g. a low-potential-side power supply line). The nth unit circuit Jn may have a third transistor T3 to which a set signal Qn−1 from a preceding unit circuit is inputted and a fourth transistor T4 to which a reset signal Qn+2 from a subsequent unit circuit is inputted. The control node NZ may be connected to the first power supply line D1 via the third transistor T3 and connected to the second power supply line D2 via the fourth transistor T4.

The nth unit circuit Jn may have an inverting node NR that is put in the opposite state to the control node NZ and a plurality of pull-down transistors T11 to T14 whose gate terminals are connected to the inverting node NR.

The setting terminal Un and the control node NZ may be connected to the second power supply line D2 (low-potential-side power supply line) via different pull-down transistors. That is, the setting terminal Un may be connected to the second power supply line D2 via the pull-down transistor T13, and the control node NZ may be connected to the second power supply line D2 via the pull-down transistor T14.

In this way, while the pull-down transistors T13 and T14 are turned off in the period LZ, during which the control node NZ is active (High), the control node NZ becomes non-active (Low) (that is, the inverting node NR becomes active High), whereby the setting transistor Tq is turned off and the pull-down transistors T13 and T14 are turned on. This causes the potentials of the setting terminal Un and the control node NZ to be maintained at a Low level regardless of the level of the clock signal K1 and causes the setting signal On to be maintained as non-active (Low).

The first driving terminal Xn and the second driving terminal Yn may be connected to the second power supply line D2 via different pull-down transistors. That is, the first driving terminal Xn may be connected to the second power supply line D2 via the pull-down transistor T11, and the second driving terminal Yn may be connected to the second power supply line D2 via the pull-down transistor T12.

In this way, while the pull-down transistors T11 and T12 are turned off in the period LZ, during which the control node NZ is active (High), the control node NZ becomes non-active (Low) (that is, the inverting node NR becomes active High), whereby the first and second transistors T1 and T2 are turned off and the pull-down transistors T11 and T12 are turned on. This causes the potentials of the first and second driving terminals Xn and Yn to be maintained at a Low level regardless of the levels of the first and second pulse signals P1 and P2 and causes the first and second driving signals Va and Vb to be maintained as non-active (Low).

In the nth unit circuit Jn, the inverting node NR may be connected to the first power supply line D1 (high-potential-side power supply line) via a diode-connected transistor T9 (power supply transistor) and connected to the second power supply line D2 (low-potential-side power supply line) via a transistor T10 (inverting transistor), and a gate terminal of the transistor T10 may be connected to the control node NZ. The transistors T9 to T14 may constitute an inverting circuit.

Although, in FIGS. 3 to 5, the setting transistor Tq, the transistors T1 to T4, and the transistors T9 to T14 may be n-channel transistors, this is not intended to impose any limitation. These transistors may be constituted by p-channel transistors, or these transistors may be constituted by n-channel transistors and p-channel transistors.

As shown in FIG. 1, the driver circuit 20 may include a signal generation circuit 30 that generates the clock signals K1 to K6 and the first to third pulse signals P1 to P3 and an input line group 25 through which the clock signals K1 to K6 and the first to third pulse signals P1 to P3 are transmitted.

FIG. 6 is a block diagram showing a configuration of a display device according to the present embodiment. As shown in FIG. 6, a display device 50 according to the present embodiment may include the display unit 40, a data driver 2, a scan driver 3, and a controller 4. The display unit 40 may be capable of setting refresh rates on an area-by-area basis. The driver circuit 20 may include the scan driver 3 (shift register circuit), the controller 4, and the input line group 25. The controller 4 may include the signal generation circuit 30 and a processor 35. The controller 4 may be a timing controller.

In the display device 50, the display unit 40 may have a plurality of liquid crystal capacitors (including a pixel electrode, a counter electrode, and a liquid crystal layer), and the driver circuit 20 may be a scan driver that drivees scanning lines of the display unit 40. The display device 50 may include a data driver 35 that drives data lines of the display unit 40.

In the display device 50, the display unit 40 may have a plurality of light-emitting elements (e.g. organic light-emitting diodes and quantum dot light-emitting diodes), and the driver circuit 20 may be a scan driver or a light emission control driver.

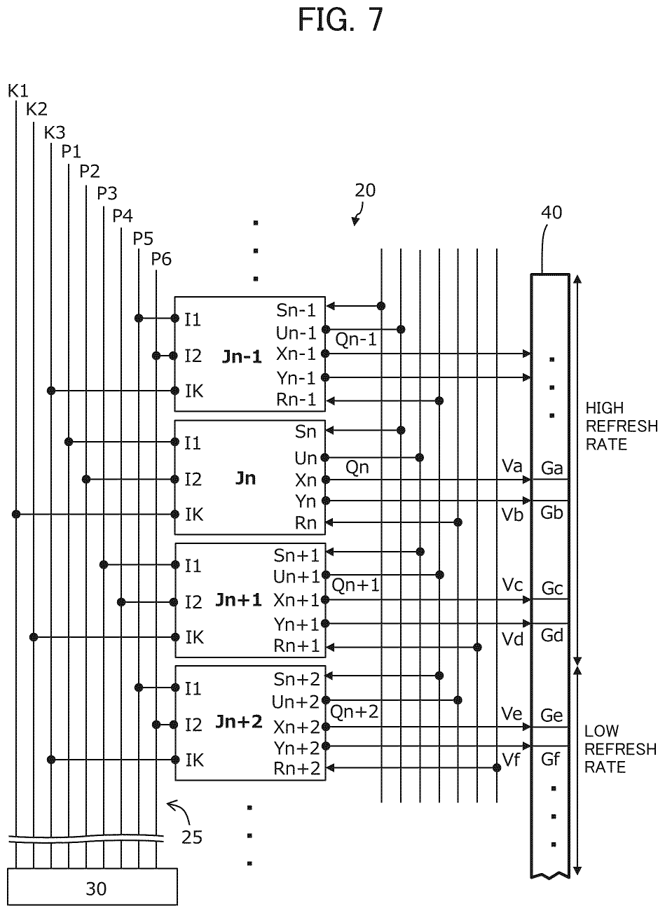

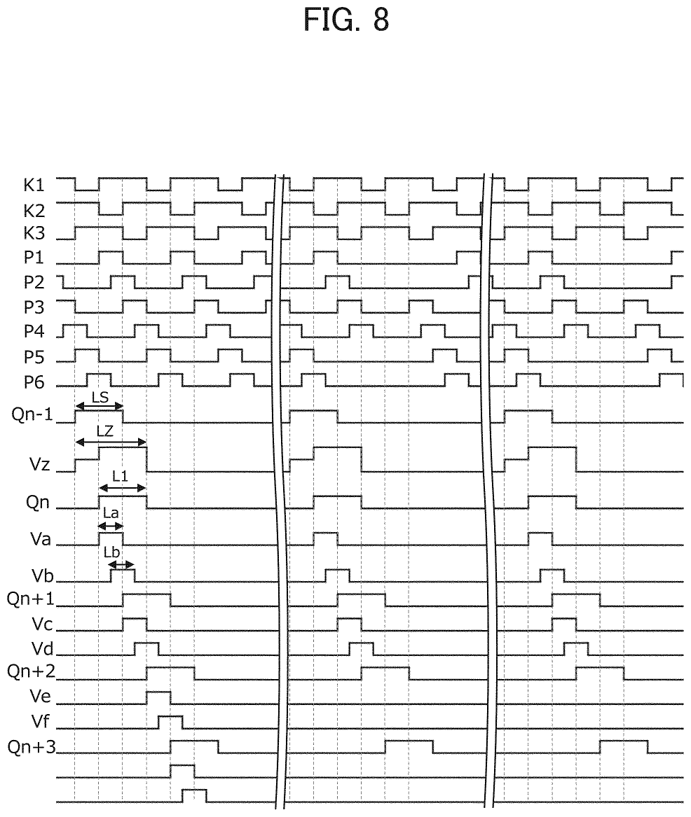

FIG. 7 is a schematic view showing a configuration of a driver circuit according to the present embodiment. FIG. 8 is a timing chart showing operation of the driver circuit according to the present embodiment. In FIGS. 1 and 2, the area including the signal lines (scanning lines) Ga to Gd is refreshed at a low refresh rate, and the area including the signal lines (scanning lines) Ge and Gf is refreshed at a high refresh rate; however, as shown in FIGS. 7 and 8, by reducing the numbers of pulses of the pulse signals P1, P2, P5, and P6, the area including the signal lines (scanning lines) Ga to Gd may be refreshed at a high refresh rate, and the area including the signal lines (scanning lines) Ge and Gf may be refreshed at a low refresh rate.

As noted above, in the display device 50 including the driver circuit 20, the respective refreshed rates (frequencies of rewriting) of the plurality of areas of the display unit 40 can be arbitrarily set by reducing the number of pulses in a reference pulse pattern (i.e. setting a pulse pattern) in a case where all areas are refreshed at a reference refresh rate (e.g. 60 Hz) for the first to sixth pulse signals P1 to P6. The pulse pattern may be set by the signal generation circuit 30 and the controller 4 cooperating with each other.

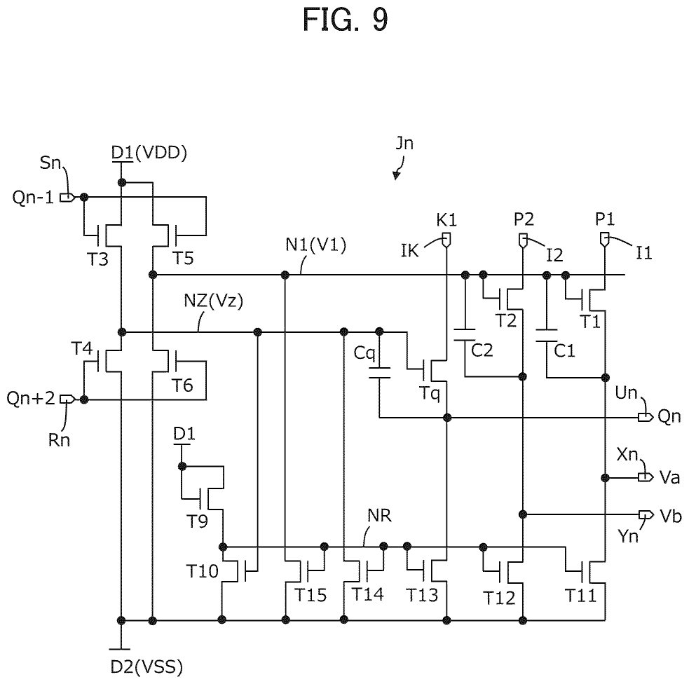

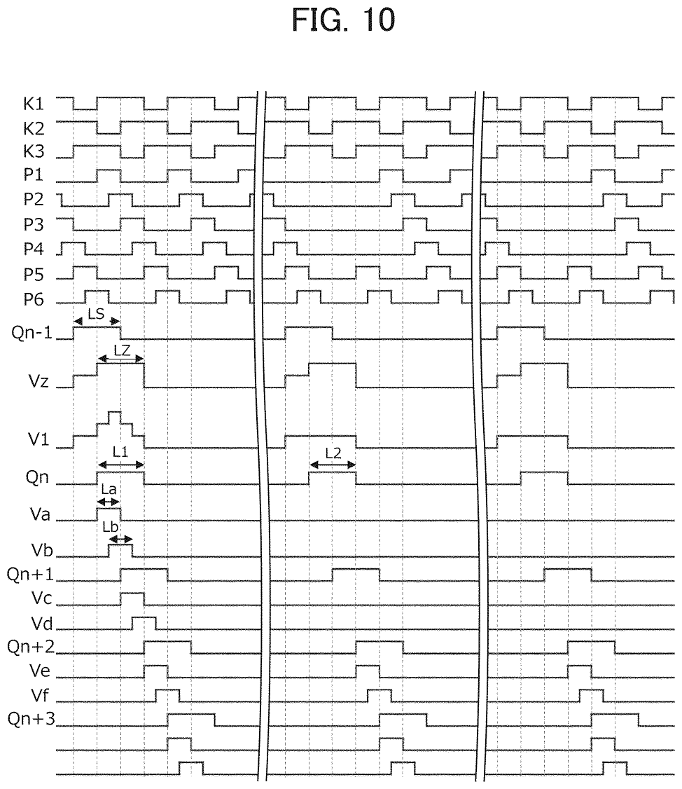

FIG. 9 is a schematic view showing a configuration of a driver circuit according to the present embodiment. FIG. 10 is a timing chart showing operation of the driver circuit according to the present embodiment. As shown in FIG. 9, the nth unit circuit Jn may have, in addition to the control node NZ, a first node N1 that becomes active in the set period LS. In this case, the control node NZ may be connected to the gate terminal of the setting transistor Tq, and the first node N1 may be connected to gate terminals of the first and second transistors T1 and T2. The control node NZ is at a potential Vz, and the first node N1 is at a potential V1.

The nth unit circuit Jn shown in FIG. 9 may have first and second capacitors C1 and C2. The gate terminal of the first transistor T1 may be connected to the first driving terminal Xn via the first capacitor C1, and the gate terminal of the second transistor T2 may be connected to the second driving terminal Yn via the second capacitor C2.

The nth unit circuit Jn may have third and fifth transistors T3 and T5 to which a set signal from a preceding unit circuit is inputted and fourth and sixth transistors T4 and T6 to which a reset signal from a subsequent unit circuit is inputted.

The control node NZ may be connected to the first power supply line D1 (high-potential-side power supply line) via the third transistor T3 and connected to the second power supply line D2 (low-potential-side power supply line) via the fourth transistor T4. The first node N1 may be connected to the first power supply line DI via the fifth transistor T5 and connected to the second power supply line D2 via the sixth transistor T6.

The nth unit circuit Jn may have an inverting node NR that is put in the opposite state to the control node NZ and a plurality of pull-down transistors T11 to T15 whose gate terminals are connected to the inverting node NR.

The setting terminal Un, the control node NZ, and the first node N1 may be connected to the second power supply line D2 via different pull-down transistors. That is, the setting terminal Un may be connected to the second power supply line D2 via the pull-down transistor T13. The control node NZ may be connected to the second power supply line D2 via the pull-down transistor T14. The first node N1 may be connected to the second power supply line D2 via the pull-down transistor T15.

The first driving terminal Xn and the second driving terminal Yn may be connected to the second power supply line D2 via different pull-down transistors. That is, the first driving terminal Xn may be connected to the second power supply line D2 via the pull-down transistor T11, and the second driving terminal Yn may be connected to the second power supply line D2 via the pull-down transistor T12.

In FIGS. 9 and 10, in a set period LS (i.e. a period during which Qn−1 is active), the first and second transistors T1 and T2 may be turned on and the first and second capacitors C1 and C2 may be charged by the first node N1 becoming active, and the first node N1 may be boosted by the first and second pulse signals P1 and P2 rising. This enhances the driving capabilities of the first and second transistors T1 and T2 and stabilizes the first and second driving signals Va and Vb. That is, pulses of the first pulse signal P1 are stably outputted through the first driving terminal Xn, and pulses of the second pulse signal P2 are stably outputted through the second driving terminal Yn.

By providing the first node N1, which becomes active in the set period LS, in addition to the control node NZ, and connecting the gate terminals of the first and second transistors T1 and T2 to the first node N1, a load on the control node NZ can be reduced and the influence of the first and second pulse signals P1 and P2 on the control node NZ can be reduced. This makes it possible to further stabilize the setting signal Qn.

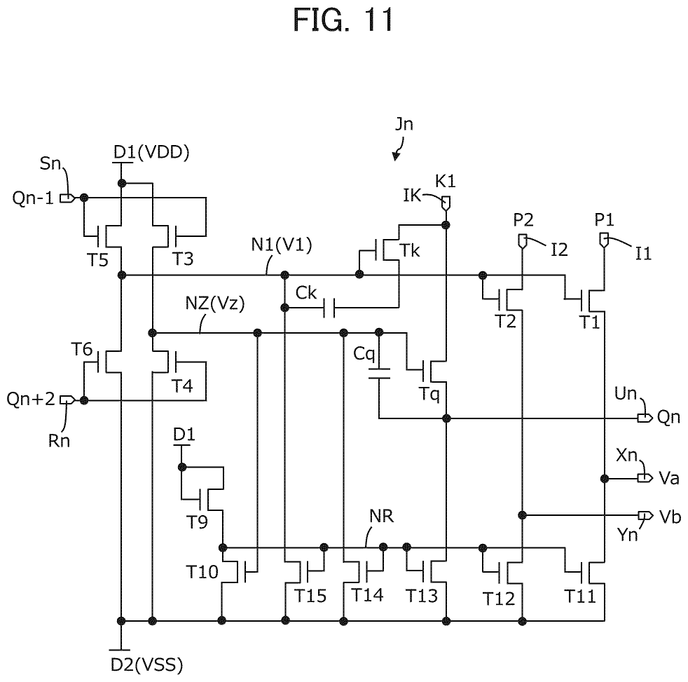

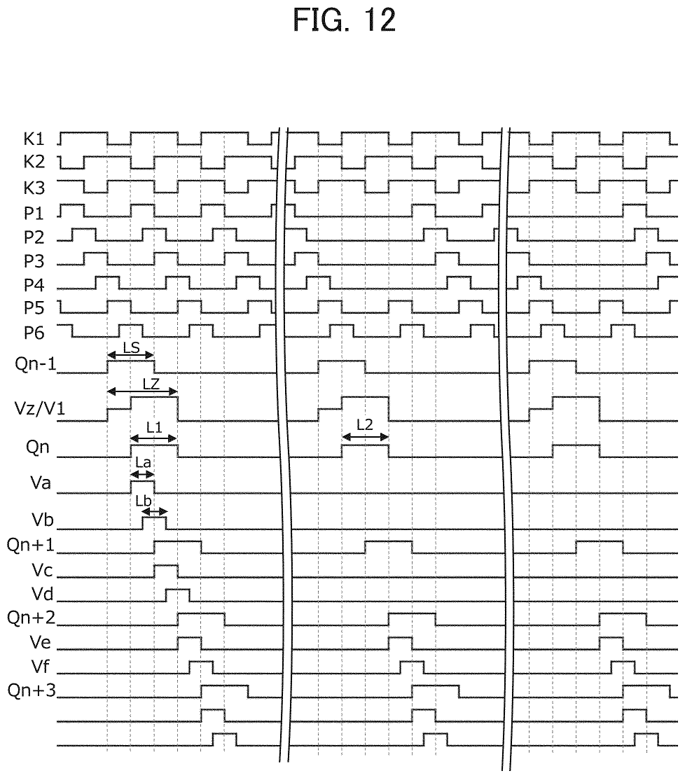

FIG. 11 is a schematic view showing a configuration of a driver circuit according to the present embodiment. FIG. 12 is a timing chart showing operation of the driver circuit according to the present embodiment. As shown in FIG. 11, the nth unit circuit Jn may have, in addition to the control node NZ, a first node N1 that becomes active in the set period LS. In this case, the control node NZ may be connected to the gate terminal of the setting transistor Tq, and the first node N1 may be connected to gate terminals of the first and second transistors T1 and T2. The control node NZ is at a potential Vz, and the first node N1 is at a potential V1.

The nth unit circuit Jn shown in FIG. 11 may have a control capacitor Ck and a control transistor Tk, and the first node N1 may be connected to the clock terminal IK via the control capacitor Ck and the control transistor Tk.

The nth unit circuit Jn may have third and fifth transistors T3 and T5 to which a set signal from a preceding unit circuit is inputted and fourth and sixth transistors T4 and T6 to which a reset signal from a subsequent unit circuit is inputted.

The control node NZ may be connected to the first power supply line D1 (high-potential-side power supply line) via the third transistor T3 and connected to the second power supply line D2 (low-potential-side power supply line) via the fourth transistor T4. The first node N1 may be connected to the first power supply line D1 via the fifth transistor T5 and connected to the second power supply line D2 via the sixth transistor T6.

The nth unit circuit Jn may have an inverting node NR that is put in the opposite state to the control node NZ and a plurality of pull-down transistors T11 to T15 whose gate terminals are connected to the inverting node NR.

The setting terminal Un, the control node NZ, and the first node N1 may be connected to the second power supply line D2 via different pull-down transistors. That is, the setting terminal Un may be connected to the second power supply line D2 via the pull-down transistor T13. The control node NZ may be connected to the second power supply line D2 via the pull-down transistor T14. The first node N1 may be connected to the second power supply line D2 via the pull-down transistor T15.

The first driving terminal Xn and the second driving terminal Yn may be connected to the second power supply line D2 via different pull-down transistors. That is, the first driving terminal Xn may be connected to the second power supply line D2 via the pull-down transistor T11, and the second driving terminal Yn may be connected to the second power supply line D2 via the pull-down transistor T12.

In FIGS. 11 and 12, in a set period LS, the setting transistor Tq may be turned on and the bootstrap capacitor Cq may be charged by the control node NZ becoming active, and the control node NZ may be boosted by the clock signal K1 rising. This enhances the driving capability of the setting transistor Tq and stabilizes the setting signal Qn. That is, pulses of the clock signal K1 are stably outputted through the setting terminal Un.

In a set period LS, the control transistor Tk and the first and second transistors T1 and T2 may be turned on and the control capacitor Ck may be charged by the first node N1 becoming active, and the first node N1 may be boosted by the clock signal K1 rising. That is, the control capacitor Ck boosts (bootstraps) the gate potentials of the first and second transistors T1 and T2. This enhances the driving capabilities of the first and second transistors T1 and T2 and stabilizes the first and second driving signals Va and Vb. That is, pulses of the first pulse signal P1 are stably outputted through the first driving terminal Xn, and pulses of the second pulse signal P2 are stably outputted through the second driving terminal Yn.

In the nth unit circuit Jn shown in FIG. 11, by providing the first node N1, which becomes active in the set period LS, in addition to the control node NZ, and connecting the control capacitor Ck and the gate terminals of the first and second transistors T1 and T2 to the first node N1, a load on the control node NZ can be reduced and the influence of the first and second pulse signals P1 and P2 on the control node NZ can be reduced. This makes it possible to further stabilize the setting signal Qn.

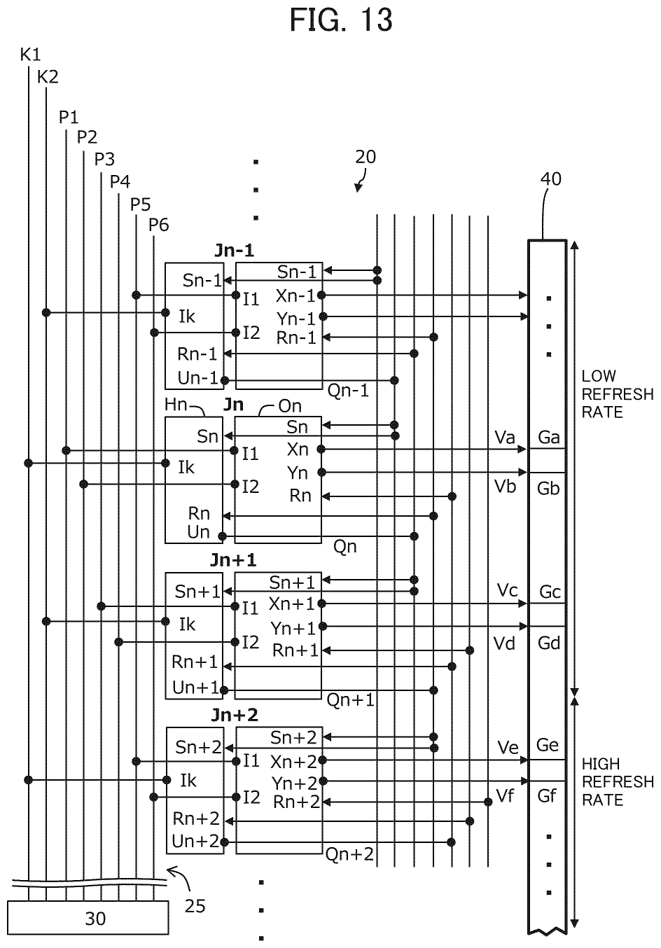

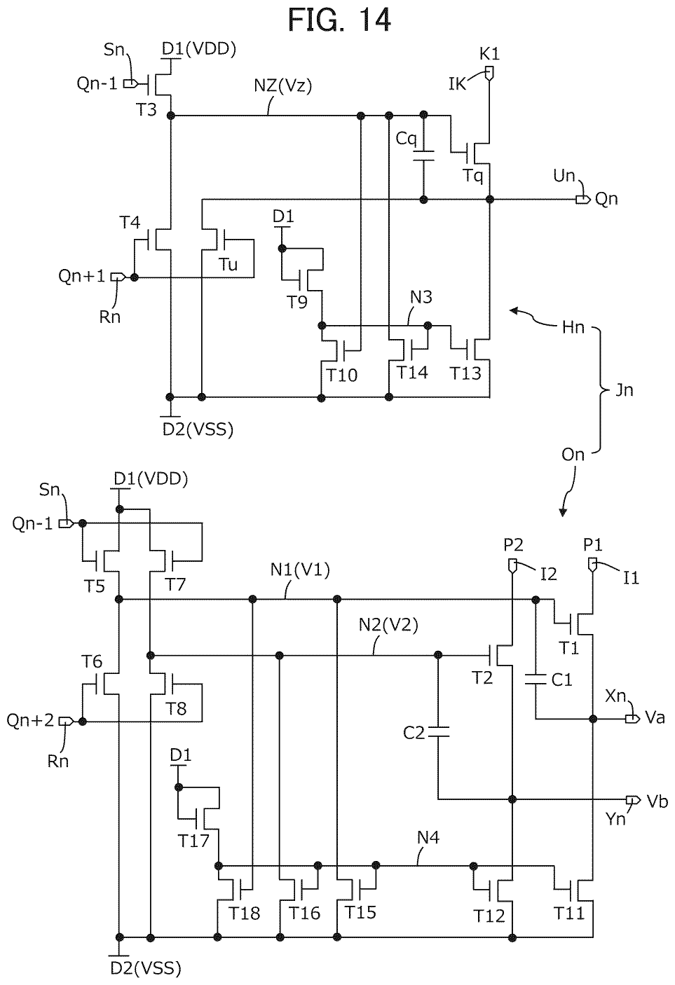

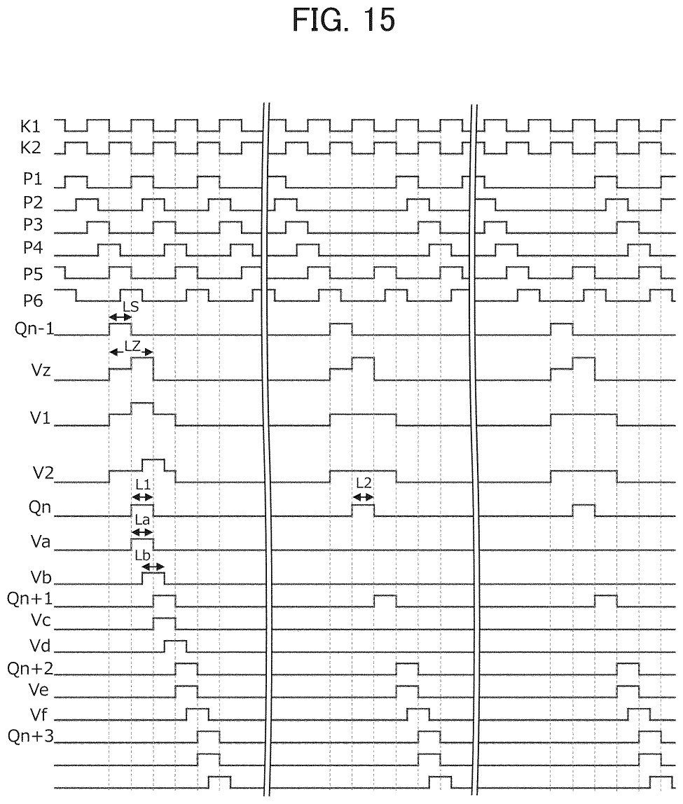

FIG. 13 is a schematic view showing a configuration of a driver circuit according to the present embodiment. FIG. 14 is a circuit diagram showing a configuration of a unit circuit of the driver circuit according to the present embodiment. FIG. 15 is a timing chart showing operation of the driver circuit according to the present embodiment. As shown in FIGS. 13 and 14, the nth unit circuit Jn may have, in addition to the control node NZ and the first node N1, a second node N2 that becomes active in the set period LS. The first node N1 may be connected to a gate terminal of the first transistor T1, and the second node N2 may be connected to a gate terminal of the second transistor T2. The control node NZ is at a potential Vz, the first node N1 at a potential V1, and the second node N2 at a potential V2.

The nth unit circuit Jn shown in FIGS. 13 and 14 may include a register circuit Hn including the control node NZ and the setting terminal Un and an output circuit On including the first and second nodes N1 and N2 and the first and second driving terminals Xn and Yn.

The register circuit Hn may have a setting terminal Un through which a set signal Qn is outputted to another unit circuit (such as Jn+1), a clock terminal IK through which the clock signal K1 is inputted, a setting transistor Tq, and a bootstrap capacitor (transformer capacitor) Cq. The setting terminal Un may be connected to the clock terminal IK via the setting transistor Tq. The control node NZ may be connected to the setting terminal Un via the bootstrap capacitor Cq.

The register circuit Hn may have a third transistor T3 to which a set signal (Qn−1) from a preceding unit circuit is inputted and a fourth transistor T4 to which a reset signal (Qn+1) from a subsequent unit circuit is inputted. The control node NZ may be connected to the first power supply line D1 (high-potential-side power supply line, VDD line) via the third transistor T3 and connected to the second power supply line D2 (low-potential-side power supply line, VSS line) via the fourth transistor T4.

The register circuit Hn may have a discharge transistor Tu to which a reset signal (Qn+1) from a subsequent unit circuit is inputted. The setting terminal Un may be connected to the second power supply line D2 via the discharge transistor Tu.

The register circuit Hn may have a third node N3 that is put in the opposite state to the control node NZ and a plurality of pull-down transistors T13 and T14 whose gate terminals are connected to the third node N3. The setting terminal Un and the control node NZ are connected to the second power supply line D2 via different pull-down transistors. That is, the setting terminal Un may be connected to the second power supply line D2 via the pull-down transistor T13, and the control node NZ may be connected to the second power supply line D2 via the pull-down transistor T14.

In the register circuit Hn, the third node N3 is connected to the first power supply line D1 (high-potential-side power supply line) via a diode-connected transistor T9 (power supply transistor) and connected to the second power supply line D2 (low-potential-side power supply line) via a transistor T10 (inverting transistor), and a gate terminal of the transistor T10 may be connected to the control node NZ.

The output circuit On may have a first input terminal I1 to which a first pulse signal P1 is inputted, a second input terminal I2 to which a second pulse signal P2 is inputted, first and second transistors T1 and T2, a first driving terminal Xn through which a first driving signal Va is outputted to the signal line Ga of the display unit 40, and a second driving terminal Yn through which a second driving signal Vb is outputted to the signal line Gb of the display unit 40. The first driving terminal Xn may be connected to the first input terminal I1 via the first transistor T1, and the second driving terminal Yn may be connected to the second input terminal I2 via the second transistor T2.

In the register circuit Hn, in a set period LS, the setting transistor Tq may be turned on and the bootstrap capacitor Cq may be charged by the control node NZ becoming active, and the control node NZ may be boosted by the clock signal K1 rising. This enhances the driving capability of the setting transistor Tq and stabilizes the setting signal Qn. That is, pulses of the clock signal K1 are stably outputted through the setting terminal Un.

The output circuit On may have first and second capacitors C1 and C2. The gate terminal of the first transistor T1 may be connected to the first driving terminal Xn via the first capacitor C1, and the gate terminal of the second transistor T2 may be connected to the second driving terminal Yn via the second capacitor C2.

The output circuit On may have fifth and seventh transistors T5 and T7 to which a set signal (Qn−1) from a preceding unit circuit is inputted and sixth and eighth transistors T6 and T8 to which a reset signal (Qn+2) from a subsequent unit circuit is inputted. The first node N1 may be connected to the first power supply line D1 via the fifth transistor T5 and connected to the second power supply line D2 via the sixth transistor T6. The second node N2 may be connected to the first power supply line D1 via the seventh transistor T7 and connected to the second power supply line D2 via the eighth transistor T8.

The output circuit On may have a fourth node N4 that is put in the opposite state to the first and second nodes N1 and N2 and a plurality of pull-down transistors T11, T12, T15, and T16 whose gate terminals are connected to the fourth node N4.

The first and second nodes N1 and N2 may be connected to the second power supply line D2 via different pull-down transistors. That is, the first node N1 may be connected to the second power supply line D2 via the pull-down transistor T15, and the second node N2 may be connected to the second power supply line D2 via the pull-down transistor T16.

The first and second driving terminals Xn and Yn may be connected to the second power supply line D2 via different pull-down transistors. That is, the first driving terminal Xn may be connected to the second power supply line D2 via the pull-down transistor T11, and the second driving terminal Yn may be connected to the second power supply line D2 via the pull-down transistor T12.

In the output circuit On, the fourth node N4 may be connected to the first power supply line D1 (high-potential-side power supply line) via a diode-connected transistor T17 (power supply transistor) and connected to the second power supply line D2 (low-potential-side power supply line) via a transistor T18 (inverting transistor). A gate terminal of the transistor T18 may be connected to the first node N1 or the second node N2.

In the output circuit On, in a set period LS, the first transistor T1 may be turned on and the first capacitor C1 may be charged by the first node N1 becoming active, and the first node N1 may be boosted by the first pulse signal P1 rising. Further, in the set period LS, the second transistor T2 may be turned on and the second capacitor C2 may be charged by the second node N2 becoming active, and the second node N2 may be boosted by the second pulse signal P2 rising.

This enhances the driving capabilities of the first and second transistors T1 and T2 and stabilizes the first and second driving signals Va and Vb. That is, pulses of the first pulse signal P1 are stably outputted through the first driving terminal Xn, and pulses of the second pulse signal P2 are stably outputted through the second driving terminal Yn.

In the driver circuit 20 shown in FIGS. 13 to 15, the setting signal On is active during the first period L1, and the first period L1 overlaps at least part of the active period La of the first driving signal Va and at least part of the active period Lb of the second driving signal Vb.

In the driver circuit 20, the two signal lines Ga and Gb can be driven by the first and second driving signals Va and Vb generated by the output circuit On. This causes the driver circuit 20 to have a decreased circuit size.

The plurality of signal lines Ga to Gf may be scanning lines, and the first and second driving signals Va and Vb may be scan signals (scanning signals). The signal line Ga may be the (2n−1)th scanning line formed in a display unit 40, and the signal line Gb may be the (2n)th scanning line formed in the display unit 40.

In the nth unit circuit Jn, a period LZ during which a gate terminal (control node NZ) of the setting transistor Tq stays active (High) may include the active period La of the first driving signal Va and the active period Lb of the second driving signal Vb.

In the driver circuit 20, the setting signal Qn may be active during a second period L2, and the first and second driving signals Va and Vb may be non-active during the second period L2. That is, total scanning by which all of the plurality of signal lines (including Ga to Gf) are scanned and partial scanning by which only some of the plurality of signal lines (including Ge and Gf) are scanned may be performed. This makes it possible to vary refresh rates (frequencies of rewriting) from one area to another in the display unit 40 (including the signal lines Ga to Gf) that is to be driven.

As shown in FIG. 15, in the driver circuit 20, the first and second driving signals Va and Vb may become active (rise from Low to High) in sequence within the first period L1. Part (e.g. the second half) of the active period La of the first driving signal Va and part (e.g. the first half) of the active period Lb of the second driving signal Vb may overlap each other. The first driving signal Va may return to non-active (Low) in the first period L1, and the second driving signal Vb may return to non-active (Low) after the end of the first period L1. In the first period L1, the first and second pulse signals P1 and P2 may become active in sequence while the clock signal K1 stays active.

Although, in FIG. 15, the first and second pulse signals P1 and P2 are equal in pulse width to each other and different in phase from each other and the pulse width of the clock signal K1 is a natural number multiple of (e.g. one time as great as) the pulse width of the first and second pulse signals P1 and P2, this is not intended to impose any limitation. Further, although a timing at which the clock signal K1 becomes active (rises) and a timing at which the first pulse signal P1 becomes active (rises) are in synchronization with each other, this is not intended to impose any limitation.

In FIG. 15, a phase shift between the first and second pulse signals P1 and P2 may be one horizontal scanning period (1 H). For example, the clock signal K1 is active for 2 H out of 4 H periodicity, and the first and second pulse signals P1 and P2 are active for 2 H out of 6 H periodicity. 1 H may be one horizontal scanning period.

As shown in FIG. 15, the setting signal Qn may be active during the second period L2, and the numbers of pulses in the first and second pulse signals P1 and P2 during the second period L2 may be reduced.

To the driver circuit 20, a clock signal group (K1 and K2) of two or more phases including the clock signal K1 and a pulse signal group (P1 to P6) of three or more phases including the first and second pulse signals P1 and P2 may be inputted. The number of phases of the clock signal group (in FIG. 15, the two phases K1 and K2) may be smaller than the number of phases of the pulse signal group (in FIG. 15, the six phases P1 to P6).

In the nth unit circuit Jn shown in FIGS. 13 and 14, the output circuit On, which includes the first and second nodes N1 and N2, is provided in addition to the register circuit Hn, which includes the control node NZ. The gate terminal of the first transistor T1 is connected to the first node N1, and the gate terminal of the second transistor T2 is connected to the second node N2. This makes it possible to reduce a load on the control node NZ and reduce the influence of the first and second pulse signals P1 and P2 on the control node NZ. This makes it possible to further stabilize the setting signal Qn.

Further, providing the first and second nodes N1 and N2 in the output circuit On makes it possible to substantially remove the influence of the second pulse signal P2 on the first node N1 and the influence of the first pulse signal P1 on the second node N2. This makes it possible to further stabilize the first and second driving signals Va and Vb.

Each of the aforementioned embodiments is for illustrative and explanatory purposes and not for limitative purposes. Based on these illustrations and explanations, it is obvious to persons skilled in the art that many modifications become possible.

The following describes the scope of the present embodiment. The term “aforementioned” hereinafter encompasses technical contents disclosed at least one of FIGS. 1 to 15.

### Conclusion

A driver circuit for driving a plurality of signal lines includes a plurality of unit circuits including an nth unit circuit. The nth unit circuit has a setting terminal through which a setting signal is outputted to another unit circuit and a plurality of driving terminals including a first driving terminal through which a first driving signal is outputted to one of the plurality of signal lines and a second driving terminal through which a second driving signal is outputted to another one of the plurality of signal lines. The setting signal is active during a first period. The first period includes at least part of an active period of the first driving signal and at least part of an active period of the second driving signal.

In the aforementioned driver circuit, the nth unit circuit may have a setting transistor having two conducting terminals one of which a clock signal is inputted through and the other of which is connected to the setting terminal, and a period during which a gate terminal of the setting transistor stays active may overlapped by (may include) at least part of the active period of the first driving signal and at least part of the active period of the second driving signal.

In the aforementioned driver circuit, the setting signal may be active during a second period, and the first driving signal and the second driving signal may be non-active during the second period.

In the aforementioned driver circuit, the setting signal may function as a set signal, and another unit circuit may be set during the first period and the second period.

In the aforementioned driver circuit, the first and second driving signals may become active in sequence within the first period.

In the aforementioned driver circuit, part of the active period of the first driving signal and part of the active period of the second driving signal may overlap each other.

In the aforementioned driver circuit, the first and second driving signals may return to non-active in the first period.

In the aforementioned driver circuit, the first driving signal may return to non-active in the first period, and the second driving signal may return to non-active after an end of the first period.

In the aforementioned driver circuit, the nth unit circuit may have a first input terminal through which a first pulse signal is inputted, a second input terminal through which a second pulse signal is inputted, a clock terminal through which a clock signal is inputted, a setting transistor, a first transistor, and a second transistor. The first driving terminal may be connected to the first input terminal via the first transistor. The second driving terminal may be connected to the second input terminal via the second transistor. The setting terminal may be connected to the clock terminal via the setting transistor.

In the aforementioned driver circuit, in the first period, the first and second pulse signals may become active in sequence while the clock signal stays active.

In the aforementioned driver circuit, the first and second pulse signals may be equal in pulse width to each other and different in phase from each other, and the pulse width of the clock signal may be a natural number multiple of the pulse width of the first and second pulse signals.

In the aforementioned driver circuit, a timing at which the clock signal becomes active and a timing at which the first pulse signal becomes active may be in synchronization with each other.

In the aforementioned driver circuit, a phase shift between the first and second pulse signals may be equivalent to one horizontal scanning period.

In the aforementioned driver circuit, the setting signal may be active during the second period, and the numbers of pulses in the first and second pulse signals during the second period may be reduced.

In the aforementioned driver circuit, a clock signal group of two or more phases including the clock signal and a pulse signal group of three or more phases including the first and second pulse signals may be inputted.

In the aforementioned driver circuit, the number of phases of the clock signal group may be smaller than the number of phases of the pulse signal group.

In the aforementioned driver circuit, the plurality of signal lines may be scanning lines, and the first driving signal and the second driving signal may be scan signals.

In the aforementioned driver circuit, the plurality of signal lines may be formed in a display unit that is capable of setting refresh rates on an area-by-area basis.

In the aforementioned driver circuit, total scanning by which all of the plurality of signal lines are scanned and partial scanning by which some of the plurality of signal lines are scanned may be performed.

In the aforementioned driver circuit, the nth unit circuit may have a control node connected to a gate terminal of the setting transistor and a bootstrap capacitor, and the control node may be connected to the setting terminal via the bootstrap capacitor.

In the aforementioned driver circuit, in a set period, the setting transistor may be turned on and the bootstrap capacitor may be charged by the control node becoming active, and the control node may be boosted by the clock signal rising.

In the aforementioned driver circuit, the control node may be connected to gate terminals of the first and second transistors.

The aforementioned driver circuit may further include a first power supply line and a second power supply line. The nth unit circuit may have a third transistor to which a set signal from a preceding unit circuit is inputted and a fourth transistor to which a reset signal from a subsequent unit circuit is inputted, and the control node may be connected to the first power supply line via the third transistor and connected to the second power supply line via the fourth transistor.

In the aforementioned driver circuit, the nth unit circuit may have, in addition to the control node, a first node that becomes active in a set period.

In the aforementioned driver circuit, the nth unit circuit may have a control capacitor and a control transistor, and the first node may be connected to the clock terminal via the control capacitor and the control transistor.

In the aforementioned driver circuit, the first node may be connected to gate terminals of the first and second transistors.

In the aforementioned driver circuit, the nth unit circuit may have first and second capacitors. The gate terminal of the first transistor may be connected to the first driving terminal via the first capacitor. The gate terminal of the second transistor may be connected to the second driving terminal via the second capacitor.

The aforementioned driver circuit may further include a first power supply line and a second power supply line. The nth unit circuit may have third and fifth transistors to which a set signal from a preceding unit circuit is inputted and fourth and sixth transistors to which a reset signal from a subsequent unit circuit is inputted. The control node may be connected to the first power supply line via the third transistor and connected to the second power supply line via the fourth transistor. The first node may be connected to the first power supply line via the fifth transistor and connected to the second power supply line via the sixth transistor.

In the aforementioned driver circuit, the first power supply line may be a high-potential-side power supply line. The second power supply line may be a low-potential-side power supply line. The nth unit circuit may have an inverting node that is put in an opposite state to the control node and a plurality of pull-down transistors whose gate terminals are connected to the inverting node. The setting terminal and the control node may be connected to the second power supply line via different pull-down transistors.

In the aforementioned driver circuit, the first driving terminal and the second driving terminal may be connected to the second power supply line via different pull-down transistors.

In the aforementioned driver circuit, the nth unit circuit may have, in addition to the control node and the first node, a second node that becomes active in the set period. The first node may be connected to a gate terminal of the first transistor. The second node may be connected to a gate terminal of the second transistor.

The aforementioned driver circuit may further include a first power supply line and a second power supply line. The nth unit circuit include a register circuit including the control node and the setting terminal and an output circuit including the first and second nodes and the first and second driving terminal. The register circuit may have a third transistor to which a set signal from a preceding unit circuit is inputted and a fourth transistor to which a reset signal from a subsequent unit circuit is inputted. The control node may be connected to the first power supply line via the third transistor and connected to the second power supply line via the fourth transistor.

In the aforementioned driver circuit, the register circuit may have a discharge transistor to which a reset signal from a subsequent unit circuit is inputted, and the setting terminal may be connected to the second power supply line via the discharge transistor.

In the aforementioned driver circuit, the first power supply line may be a high-potential-side power supply line. The second power supply line may be a low-potential-side power supply line. The register circuit may have a third node that is put in an opposite state to the control node and a plurality of pull-down transistors whose gate terminals are connected to the third node. The setting terminal and the control node may be connected to the second power supply line via different pull-down transistors.

In the aforementioned driver circuit, the output circuit may have fifth and seventh transistors to which a set signal from a preceding unit circuit is inputted and sixth and eighth transistors to which a reset signal from a subsequent unit circuit is inputted. The first node may be connected to the first power supply line via the fifth transistor and connected to the second power supply line via the sixth transistor. The second node may be connected to the first power supply line via the seventh transistor and connected to the second power supply line via the eighth transistor.

In the aforementioned driver circuit, the output circuit may have a fourth node that is put in an opposite state to the first node and the second node and a plurality of pull-down transistors whose gate terminals are connected to the fourth node, and the first driving terminal and the second driving terminal may be connected to the second power supply line via different pull-down transistors.

The aforementioned driver circuit may further include a signal generation circuit that generates the clock signal and the first and second pulse signals and an input line group through which the clock signal and the first and second pulse signals are transmitted.

A display device includes the aforementioned driver circuit.

The aforementioned display device may further include a display unit that is capable of setting refresh rates on an area-by-area basis.

The present disclosure contains subject matter related to that disclosed in Japanese Priority Patent Application JP 2024-110453 filed in the Japan Patent Office on Jul. 9, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

### CROSS-REFERENCE TO RELATED APPLICATION

The present application claims priority from Japanese Application No. 2024-110453, filed on Jul. 9, 2024, the contents of which are hereby incorporated by reference into this application.

What is claimed is:

1. A driver circuit for driving a plurality of signal lines, the driver circuit comprising a plurality of unit circuits including an nth unit circuit,
wherein
the nth unit circuit has a setting terminal through which a setting signal is outputted to another unit circuit and a plurality of driving terminals including a first driving terminal through which a first driving signal is outputted to one of the plurality of signal lines and a second driving terminal through which a second driving signal is outputted to another one of the plurality of signal lines,
the setting signal is active during a first period, and
the first period includes at least part of an active period of the first driving signal and at least part of an active period of the second driving signal.

2. The driver circuit according to claim 1, wherein
the nth unit circuit has a setting transistor having two conducting terminals one of which a clock signal is inputted through and the other of which is connected to the setting terminal, and
a period during which a gate terminal of the setting transistor stays active is overlapped by at least part of the active period of the first driving signal and at least part of the active period of the second driving signal.

3. The driver circuit according to claim 1, wherein
the setting signal is active during a second period, and
the first driving signal and the second driving signal are non-active during the second period.

4. The driver circuit according to claim 3, wherein
the setting signal functions as a set signal, and another unit circuit is set during the first period and the second period.

5. The driver circuit according to claim 1, wherein the first and second driving signals become active in sequence within the first period.

6. The driver circuit according to claim 5, wherein part of the active period of the first driving signal and part of the active period of the second driving signal overlap each other.

7. The driver circuit according to claim 5, wherein the first and second driving signals return to non-active in the first period.

8. The driver circuit according to claim 5, wherein
the first driving signal returns to non-active in the first period, and
the second driving signal returns to non-active after an end of the first period.

9. The driver circuit according to claim 1, wherein
the nth unit circuit has a first input terminal through which a first pulse signal is inputted, a second input terminal through which a second pulse signal is inputted, a clock terminal through which a clock signal is inputted, a setting transistor, a first transistor, and a second transistor,
the first driving terminal is connected to the first input terminal via the first transistor,
the second driving terminal is connected to the second input terminal via the second transistor, and
the setting terminal is connected to the clock terminal via the setting transistor.

10. The driver circuit according to claim 9, wherein in the first period, the first and second pulse signals become active in sequence while the clock signal stays active.

11. The driver circuit according to claim 9, wherein
the first and second pulse signals are equal in pulse width to each other and different in phase from each other, and
the pulse width of the clock signal is a natural number multiple of the pulse width of the first and second pulse signals.

12. The driver circuit according to claim 11, wherein a timing at which the clock signal becomes active and a timing at which the first pulse signal becomes active are in synchronization with each other.

13. The driver circuit according to claim 11, wherein a phase shift between the first and second pulse signals is equivalent to one horizontal scanning period.

14. The driver circuit according to claim 9, wherein
the setting signal is active during the second period, and
the numbers of pulses in the first and second pulse signals during the second period are reduced.

15. The driver circuit according to claim 9, wherein a clock signal group of two or more phases including the clock signal and a pulse signal group of three or more phases including the first and second pulse signals are inputted.

16. The driver circuit according to claim 15, wherein the number of phases of the clock signal group is smaller than the number of phases of the pulse signal group.

17. The driver circuit according to claim 9, wherein
the nth unit circuit has a control node connected to a gate terminal of the setting transistor and a bootstrap capacitor, and
the control node is connected to the setting terminal via the bootstrap capacitor.

18. The driver circuit according to claim 17, wherein in a set period, the setting transistor is turned on and the bootstrap capacitor is charged by the control node becoming active, and the control node is boosted by the clock signal rising.

19. The driver circuit according to claim 17, wherein the control node is connected to gate terminals of the first and second transistors.

20. A display device comprising:
the driver circuit according to claim 1, and
a display unit that is capable of setting refresh rates on an area-by-area basis,
wherein the plurality of signal lines are scanning lines, and the first driving signal and the second driving signal are scan signals,
wherein the plurality of signal lines are formed in the display unit.
